(19) United States
(12) Patent Application Publication
(10) Pub. No.: US 2024/0037189 A1
(43) Pub. Date: Feb. 1, 2024

(54) DATA AUGMENTATION BY MANIPULATING OBJECT CONTENTS

(71) Applicant: PlusAI, Inc., Cupertino, CA (US)

(72) Inventors: Anurag Paul, Campbell, CA (US); Abhishek Yadav, San Jose, CA (US)

(21) Appl. No.: 17/877,236

(22) Filed: Jul. 29, 2022

(51) Int. Cl. G06K 9/62; G05D 1/00

(52) U.S. Cl. CPC G06K 9/6256; G05D 1/0088

(57) ABSTRACT

Methods, systems, and non-transitory computer-readable media are configured to perform operations comprising determining at least one criterion for generation of augmented data to be included in a set of training data for training a machine learning model. At least one base template and at least one component are selected based on the at least one criterion. The augmented data is generated based on the at least one base template and the at least one component.

### FIELD OF THE INVENTION

The present technology relates to autonomous systems. More particularly, the present technology relates to generating training data for training machine learning models that may be used in vehicle autonomous systems.

### BACKGROUND

An autonomous system for navigation of a vehicle can plan and control motion for the vehicle. The planning and control functions of the autonomous system rely on data about the vehicle and an environment in which the vehicle is traveling, including movement of other vehicles. The performance of the planning and control functions can depend on such data as the state of the vehicle and the conditions of the environment change.

### SUMMARY

Various embodiments of the present technology can include methods, systems, and non-transitory computer readable media configured to determine at least one criterion for generation of augmented data to be included in a set of training data for training a machine learning model. At least one base template and at least one component are selected based on the at least one criterion. The augmented data is generated based on the at least one base template and the at least one component.

In some embodiments, at least one image that depicts an object is determined based on the at least one criterion. The at least one component is generated based on a part of the object.

In some embodiments, a seed for generating the at least one component is determined. The at least one component is generated based on the seed.

In some embodiments, the at least one component is selected from a component library based on the at least one criterion.

In some embodiments, at least one image that depicts an object is determined based on the at least one criterion. The at least one base template is generated based on removal of a portion of the object depicted in the at least one image.

In some embodiments, the at least one base template is selected from a template library. A portion of the at least one base template is removed based on the at least one criterion.

In some embodiments, removal of the portion of the at least one base template comprises replacement of the portion with a background color.

In some embodiments, a portion of the at least one base template is modified to include the at least one component based on the at least one criterion.

In some embodiments, the augmented data is labeled based on the at least one base template and the at least one component.

In some embodiments, the determining the at least one criterion is based on insufficiency in the set of training data.

It should be appreciated that many other embodiments, features, applications, and variations of the present technology will be apparent from the following detailed description and from the accompanying drawings. Additional and alternative implementations of the methods, non-transitory computer readable media, systems, and structures described herein can be employed without departing from the principles of the present technology.

### BRIEF DESCRIPTION OF THE DRAWINGS

FIG. 1 illustrates an example augmented data module associated with generating augmented data, according to embodiments of the present technology.

FIG. 2A illustrates an example block diagram associated with generating a template library, according to embodiments of the present technology.

FIG. 2B illustrates an example block diagram associated with generating a component library, according to embodiments of the present technology.

FIG. 3 illustrates an example diagram associated with generating augmented data, according to embodiments of the present technology.

FIGS. 4A-4C illustrate example implementations of augmented data, according to embodiments of the present technology.

FIG. 5 illustrates an example method, according to embodiments of the present technology.

FIG. 6 illustrates an example vehicle, according to embodiments of the present technology.

FIG. 7 illustrates an example computing system, according to embodiments of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Data Augmentation

An autonomous system for navigation of a vehicle can plan and control motion for the vehicle. The planning and control functions of the autonomous system rely on data about the vehicle and an environment in which the vehicle is traveling, including movement of other vehicles. The performance of the planning and control functions can depend on such data as the state of the vehicle and the conditions of the environment change.

Understanding an environment in which a vehicle having an autonomous system of navigation (e.g., ego vehicle) is traveling is fundamental to planning and control functions of the vehicle. For example, a truck travelling in an environment can plan a safe route to travel in the environment based on an understanding of the environment. The understanding of the environment can involve identifying objects in the environment, such as traffic signals, traffic signs, other vehicles, pedestrians, etc. The understanding of the environment can also involve determining navigational context, such as speed limits, based on the identified objects. In many cases, an vehicle relies on machine learning models to facilitate understanding of an environment in which the vehicle is travelling. For example, an truck can rely on a machine learning model to identify objects in an environment and to determine navigational context based on the identified objects. In this example, if the machine learning model fails to accurately identify an object and thus to determine proper navigational context, the truck may face challenges in planning a safe route through the environment. Thus, a robustly trained machine learning model is critical to the planning and control functions of an vehicle.

However, under conventional approaches, robustly training a machine learning model faces various technological challenges. In many cases, training data for training a machine learning model is collected in a particular geographic region. Because the collected training data is limited to that geographic region, the training data often does not include features that are found in other geographic regions. As just one example, training data for training a machine learning model to identify speed limit signs may be manually collected in a particular geographic region where the speed limit does not exceed 55 mph. Because the speed limit of the geographic region does not exceed 55 mph, the training data does not include, for example, images of speed limit signs with speed limits over 55 mph. Accordingly, the training data would be insufficient for training the machine learning model to identify speed limit signs with speed limits over 55 mph that may be prevalent in other geographic regions. In this way, conventional techniques to train machine learning models disadvantageously result in machine learning models with limited capabilities. One way to address these disadvantages is to potentially bolster collection efforts so that training data across various geographic regions are obtained. However, this approach is often impractical and cost prohibitive.

The present technology provides improved approaches for training machine learning models that overcome the aforementioned technological challenges. In various embodiments, the present technology can generate augmented data for use as training data to train a machine learning model. The augmented data can be generated based on base templates and components. The base templates can include, for example, captured data, such as images. The captured data can be modified to remove certain portions. The portions can be replaced with components to generate the augmented data. The augmented data can be generated in accordance with augmentation criteria. The augmentation criteria can be considerations that indicate or specify, for example, training data that is needed to diversify a training data set. For example, a training data set may be used to train a machine learning model to identify speed limit signs and determine speed limits based on the speed limit signs. The training data set may lack sufficient data to train the machine learning model to determine speed limits for certain speed limit ranges, such as from 5 mph to 15 mph, from 40 mph to 55 mph, or from 70 mph to 90 mph. In accordance with the present technology, augmented data can be generated so the training data set has sufficient data to train the machine learning model to determine these speed limit ranges. Augmentation criteria can specify the need to generate augmented data for these speed limit ranges. The augmented data can be generated based on base templates and components. The base templates can include images of environments with speed limit signs. In the base templates, speed limits otherwise appearing in speed limit signs are removed. The base templates can be modified with components, which can include images of numbers from other speed limit signs, to generate the augmented data. To remedy the omission of the aforementioned speed limit ranges in the training data set, the augmented data can be generated to include images of environments with speed limit signs that have speed limits from 5 mph to 15 mph, from 40 mph to 55 mph, or from 70 mph to 90 mph. As illustrated in this example, the present technology can generate augmented data to optimally train machine learning models to account for a diverse range of scenarios, increasing robustness of the machine learning models. Moreover, the significant costs relating to collection of training data can be reduced. The present technology can provide labels for augmented data based on labels associated with the base templates and components from which the augmented data was generated. Therefore, the significant costs of labeling can be reduced. These and other inventive features and related advantages of the various embodiments of the present technology are discussed in more detail herein.

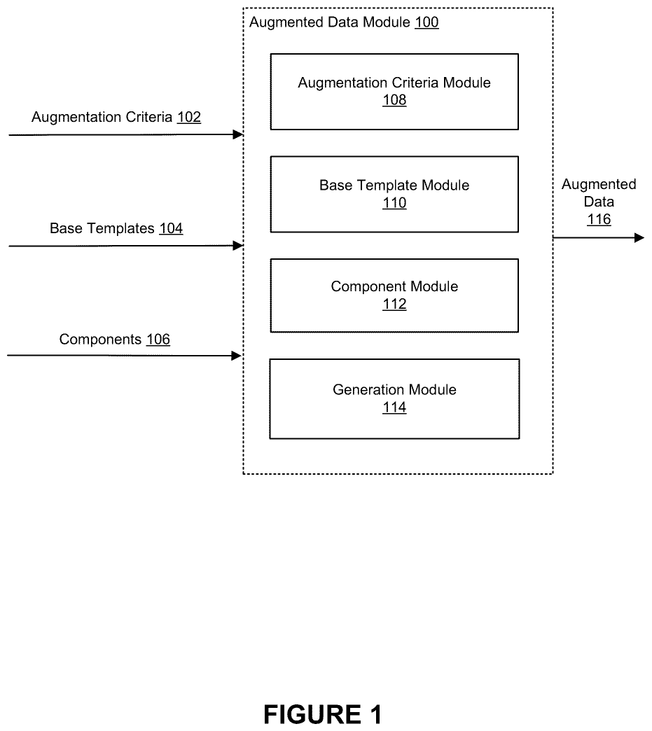

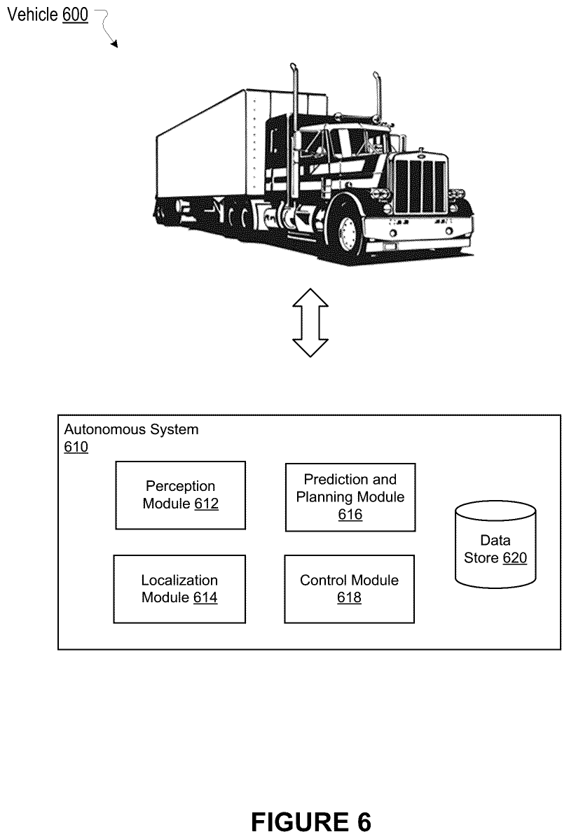

FIG. 1 illustrates an example augmented data module 100, according to some embodiments of the present technology. In some embodiments, the augmented data module 100 can provide support for various functions of an autonomous system of any type of vehicle, such as an autonomous vehicle. The augmented data module 100 can generate augmented data 116. The augmented data 116 can be training data for training a machine learning model. For example, the machine learning model can support functionality of a perception function of an autonomous system of a vehicle, such as a perception module 612 of an autonomous system 610 of FIG. 6, as discussed in more detail below. The augmented data module 100 can generate the augmented data 116 in accordance with various augmentation criteria, such as augmentation criteria 102. The augmented data module 100 can generate the augmented data 116 based on various base templates, such as base templates 104, and various components, such as components 106. The augmented data module 100 can label the augmented data 116 based on labels associated with the various base templates and the various components. In some cases, the augmented data module 100 can label the augmented data 116 without independently, or additionally, determining labels for the augmented data. While speed limit signs and vehicle navigation are discussed herein as examples of an application of the present technology, any type of training data can be augmented in accordance with the present technology to optimize training of a machine learning model to bolster robustness of the machine learning model in performing identifications, classifications, or other inferences in any type of application in any industry.

In some embodiments, some or all of the functionality performed by the augmented data module 100 may be performed by one or more computing systems. In some embodiments, some or all of the functionality performed by the augmented data module 100 may be performed by one or more backend computing systems. In some embodiments, some or all of the functionality performed by the planning module 100 may be performed by one or more computing systems associated with (e.g., carried by) one or more users riding in a vehicle. In some embodiments, some or all data processed and/or stored by the augmented data module 100 can be stored in a data store (e.g., local to the augmented data module 100) or other storage system (e.g., cloud storage remote from the augmented data module 100). The components (e.g., modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the augmented data module 100 can be implemented in any suitable combinations. Functionalities of the augmented data module 100 or variations thereof may be further discussed herein or shown in other figures.

As referenced or suggested herein, autonomous vehicles can include, for example, a fully autonomous vehicle, a partially autonomous vehicle, a vehicle with driver assistance, or an autonomous capable vehicle. The capabilities of autonomous vehicles can be associated with a classification system or taxonomy having tiered levels of autonomy. A classification system can be specified by, for example, industry standards or governmental guidelines. For example, based on the SAE standard, the levels of autonomy can be considered using a taxonomy such as level 0 (momentary driver assistance), level 1 (driver assistance), level 2 (additional assistance), level 3 (conditional assistance), level 4 (high automation), and level 5 (full automation without any driver intervention). Following this example, an autonomous vehicle can be capable of operating, in some instances, in at least one of levels 0 through 5. According to various embodiments, an autonomous capable vehicle may refer to a vehicle that can be operated by a driver manually (that is, without the autonomous capability activated) while being capable of operating in at least one of levels 0 through 5 upon activation of an autonomous mode. As used herein, the term “driver” may refer to a local operator (e.g., an operator in the vehicle) or a remote operator (e.g., an operator physically remote from and not in the vehicle). The autonomous vehicle may operate solely at a given level (e.g., level 2 additional assistance or level 5 full automation) for at least a period of time or during the entire operating time of the autonomous vehicle. Other classification systems can provide other levels of autonomy characterized by different vehicle capabilities.

The augmented data module 100 can include an augmentation criteria module 108. The augmentation criteria module 108 can determine augmentation criteria for generating augmented data. The augmentation criteria can specify objects to be included in the augmented data and how the objects are to be modified in the augmented data. The augmentation criteria can specify how the objects are to be modified in the augmented data in terms of variations to or amounts of modification of the objects. In some cases, augmentation criteria, such as augmentation criteria 102, can be provided for the augmentation criteria module 108. In some cases, the augmentation criteria module 108 can determine augmentation criteria for generating augmented data based on a set of training data. The augmentation criteria can be based on how the set of training data is insufficient or suboptimal with respect to diversity or quantity. Such insufficiency in a set of training data can be determined through a variety of techniques. For example, when the number of relevant training data examples in a set of training data falls below a threshold, the set can be determined to be insufficient. As another example, insufficiency in a set of training data used to train a machine learning model can be determined or indicated based on performance metrics (e.g., recall, precision) of the machine learning model that do not satisfy performance threshold values.

In some cases, a set of training data may be insufficient with respect to diversity in relation to a property, aspect, or other quality on which a machine learning model should be adequately trained. Augmentation criteria can be determined for generating augmented data to address the insufficiency of the set of training data by supplementing the set of training data. For example, a set of training data for training a machine learning model to identify pedestrians may be insufficient with respect to diversity in facial accessories of pedestrians, such as facemasks and sunglasses. In this example, augmentation criteria can be determined to generate augmented data that include pedestrians with different facial accessories, such as pedestrians with facemasks, pedestrians with sunglasses, and pedestrians with facemasks and sunglasses. The augmented data generated based on the augmentation criteria can supplement the set of training data, increasing the diversity of training data in the set of training data.

In some cases, a set of training data may be insufficient with respect to quantity of training data with respect to a quality on which a machine learning model should be adequately trained. As with insufficiency relating to diversity, augmentation criteria can be determined for generating augmented data to address the insufficiency of the set of training data with respect to quantity. For example, a set of training data for training a machine learning model to identify people associated with emergency services, such as police, paramedics, and firefighters, may be insufficient. Augmentation criteria can be determined for generating augmented data that include people associated with emergency services. The augmented data generated based on the augmentation criteria can supplement the set of training data, increasing the quantity of training data that include people associated with emergency services in the set of training data. Many variations are possible.

In various embodiments, the augmented data module 100 can include a base template module 110. The base template module 110 can generate base templates based on images of an environment, such as images captured by sensors (e.g., cameras) on a vehicle located in the environment. One or more machine learning models can identify objects in the captured images. The one or more machine learning models can further identify parts, or portions, of the objects. The identified objects, and the identified parts, in the captured images can be labeled, or annotated, with bounding boxes and labels as determined by the one or more machine learning models. In some cases, the captured images can be labeled through an appropriately configured software utility or application by a human reviewer who identifies the objects, and the parts thereof, and applies the appropriate bounding boxes and labels. For example, a base template can include an image of a highway environment. The image of the highway environment can include traffic signs and vehicles. The traffic signs and vehicles in the image can be labelled with respective bounding boxes and labels. Parts of the traffic signs (e.g., speed limit digits) and parts of the vehicles (e.g., windshields, side-view mirrors, bumpers, wheels) also can be labelled with respective bounding boxes and labels. Many variations are possible.

The base template module 110 can determine base templates for generating augmented data. Determining base template for generating augmented data can include selecting appropriate base templates and preparing the base templates for generating augmented data. The base template module 110 can determine the base templates for generating augmented data based on augmentation criteria. The augmentation criteria can specify objects to be included in the augmented data and how the objects are to be modified. The base template module 110 can select base templates that include the objects specified by augmentation criteria based on the labelled objects in the base templates. The base template module 110 can prepare the selected base templates so that the selected base templates can be modified as specified by the augmentation criteria. Preparing the selected base templates can involve removing portions of the base templates. The removed portions can correspond with parts of objects to be modified to generate augmented data. The removing can be performed by replacing the portion with a background color or deleting the portion. For example, augmentation criteria for generating augmented data can specify speed limit signs to be modified with respect to speed limits displayed on the speed limit signs. Base templates can be selected so that the selected base templates include images of environments that have speed limit signs. The images of the environments may also have other objects, such as pedestrians and vehicles. Based on the augmentation criteria, the parts of the speed limit signs that display speed limits are processed. In particular, the portions of the speed limit signs corresponding to the speed limits can be replaced with a background color (e.g., white) or simply deleted. Augmented data can be generated based on the prepared base templates. Many variations are possible.

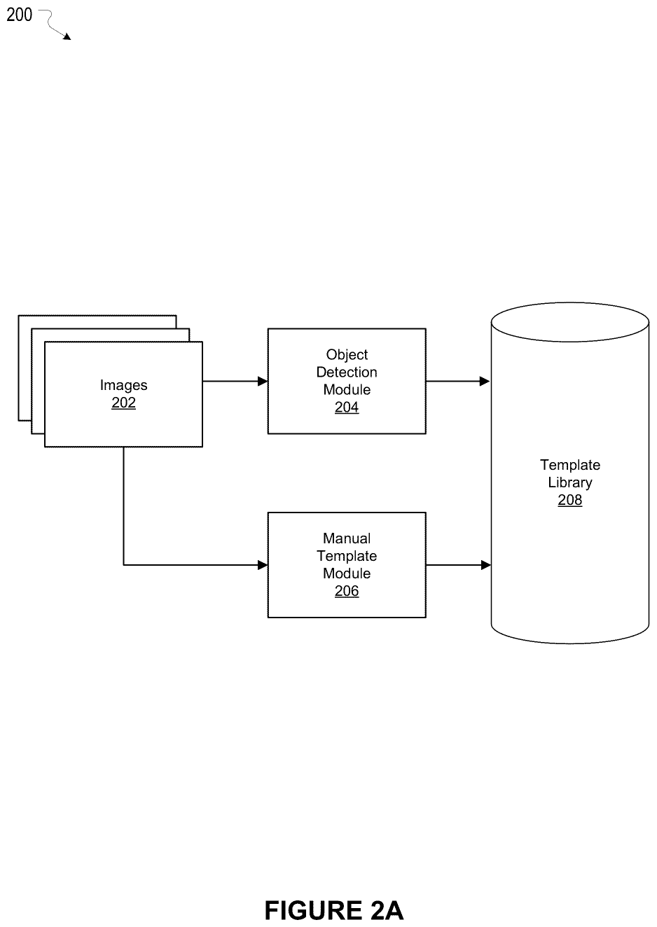

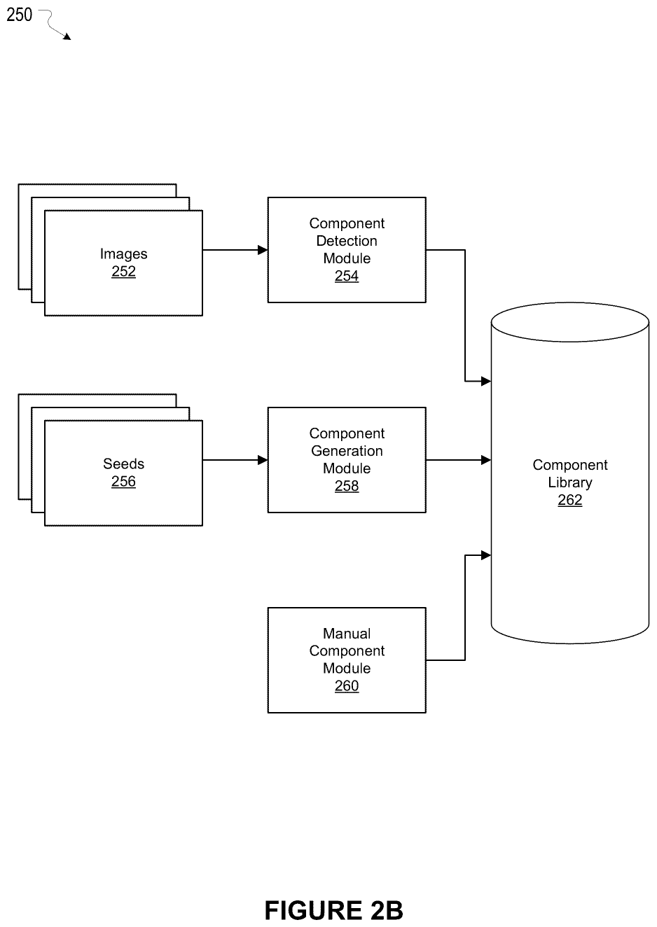

In various embodiments, the base template module 110 can select base templates, such as base templates 104, provided from a template library. The base templates 104 provided from the template library can include base templates from a variety of sources. In some cases, the base templates 104 provided from the template library can include base templates previously generated by the base template module 110. More details related to the template library are provided herein with respect to FIG. 2A.

In various embodiments, the augmented data module 100 can include a component module 112. In some cases, the component module 112 can generate components based on images of an environment, such as images captured by sensors (e.g., cameras) on a vehicle located in the environment. One or more machine learning models can identify objects in the captured images. The one or more machine learning models can further identify parts of the objects. The components can include portions of the captured images that contain the identified parts and associated labels (or characteristics) of the portions. The labels for the components can describe the identified parts of the objects. In some cases, the labels for the components can be determined based on labels associated with the identified objects from which the components were derived. For example, an image of an environment can include a speed limit sign with a speed limit of 45 mph. A machine learning model can identify the speed limit sign in the image. The machine learning model can further identify the number “4” and the number “5” in the speed limit sign. A first component can be generated based on the number “4”. A second component can be generated based on the number “5”. The first component and the second component can include those portions of the image that contain the number “4” and the number “5”. Based on the identification of the speed limit sign by the machine learning model, the first component and the second component can include labels indicating that the components are numerical digits for a speed limit sign. As another example, an image of an environment can include a vehicle. A machine learning model can identify the vehicle in the image. The machine learning model can further identify parts of the vehicle, such as doors, bumpers, wheels, windows, etc. In this example, a first component can be generated based on a door of the vehicle. A second component can be generated based on a bumper of the vehicle. A third component can be generated based on a wheel of the vehicle. A fourth component can be generated based on a window of the vehicle. The first component, the second component, the third component, and the fourth component can include portions of the images that contain, respectively, the door, the bumper, the wheel, and the window. Based on the identification of the parts of the vehicle by the machine learning model, the first component can include a label indicating the first component is a door of a vehicle. The second component can include a label indicating the second component is a bumper of a vehicle. The third component can include a label indicating the third component is a wheel of a vehicle. The fourth component can include a label indicating the fourth component is a door of a vehicle. Many variations are possible.

In some cases, the component module 112 can generate components based on seeds. One or more machine learning models can generate images of objects based on seeds. The seeds can be, for example, random noise or specified input. Images of objects generated based on random noise can have random qualities. Images of objects generated based on specified inputs can have qualities corresponding with the specified inputs. Components can be generated based on the generated images of objects. The components can include labels describing the qualities of the objects. For example, a machine learning model can generate images of human faces based on random noise seeds. The human faces can have random qualities, such as random mouth size, mouth shape, nose size, nose shape, eye size, eye shape, and skin tone. Components can be generated based on the images of the human faces and include the respective qualities of the human faces as randomly generated. As another example, a machine learning model can generate images of wheels based on random noise seeds. The wheels can have random designs. Components can be generated based on the images of the wheels. As illustrated by this example, a diverse range of images of human faces and images of wheels may be desired as human faces and wheels generally can widely vary. Thus, generation of components based on random noise seeds may be useful in cases where a diverse range of components are desired. As another example, a machine learning model can generate images of numerical digits for a speed limit sign based on a specified input. The machine learning model can generate images of numerical digits, such as “8” or “9”, based on the specified input. Components can be generated based on the images of the numerical digits and the respective numbers depicted in the images. In this example, images of certain numerical digits, such as “8” or “9”, may be relatively difficult to encounter and, therefore, relatively difficult to capture. Thus, generation of components based on specified inputs may be useful in cases where a specific component is desired. Many variations are possible.

In some cases, components can be manually generated. The component module 112 can provide a user interface and image rendering tools through which users can generate images. Labels associated with the generated images can be provided by the users. Components can be generated based on the generated images. The components can include the labels associated with the generated images. For example, a user can generate images of vehicle rear windows on which various messages have been drawn. The messages can include, for example, congratulatory or celebratory language. The user can provide labels associated with the generated images, such as labels indicating that the images are of vehicle rear windows with messages. Components can be images of the vehicle rear windows and include the labels provided by the user. Many variations are possible.

The component module 112 can determine components for generating augmented data. Determining components for generating augmented data can include selecting appropriate components. The component module 112 can determine the components for generating augmented data based on augmentation criteria. The augmentation criteria can specify variations, or ranges, for modification of an object to be included in the augmented data. The component module 112 can select components that reflect or satisfy the variations, or ranges, for modification of the object as specified by the augmentation criteria. For example, augmentation criteria for generating augmented data can specify speed limit signs to be modified with respect to speed limits displayed on the speed limit signs. The augmentation criteria can further specify ranges of speed limits, or specific speed limits, to be displayed on the speed limit signs. Based on the augmentation criteria, components that include speed limit digits that reflect the ranges of speed limits, or the specific speed limits, can be selected. Augmented data can be generated based on the selected components. Many variations are possible.

In various embodiments, the component module 112 can select components, such as components 106, provided from a component library. The components 106 provided from the component library can include components from a variety of sources. In some cases, the components 106 provided from the component library can include components previously generated by the component module 112. More details related to the component library are provided herein with respect to FIG. 2B.

In various embodiments, the augmented data can include a generation module 114. The generation module 114 can generate augmented data 116 based on base templates determined by the base template module 110 and components determined by the component module 112. The generation module 114 can apply components determined by the component module 112 to base templates determined by the base template module 110 based on augmentation criteria. The augmentation criteria can specify objects to be modified and how the objects are to be modified. The components can be applied to the base templates to reflect the augmentation criteria. Application of the components to the base templates can include modifying portions of the base templates with individual components or combinations of components in accordance with the augmentation criteria. For example, augmented data can be generated to supplement a set of training data for training a machine learning model to determine speed limits from speed limit signs. Augmentation criteria can specify the augmented data to include speed limit signs with ranges of speed limits, such as from 30 mph to 50 mph and from 65 mph to 90 mph. Based on the augmentation criteria, base templates that include speed limit signs can be determined. Further, based on the augmentation criteria, components that include speed limit digits that reflect the specified ranges can be determined. For instance, the components can be applied to the base templates to generate augmented data that include speed limit signs with speed limits of 30 mph, 35 mph, 40 mph, 50 mph, 65 mph, 70 mph, 75 mph, 80 mph, 85 mph, and 90 mph. In some cases, augmented data that includes speed limit signs with other speed limits in the specified range, such as 31 mph or 32 mph, can also be generated. As another example, augmented data can be generated to supplement a set of training data for training a machine learning model to identify vehicles. For instance, augmentation criteria can be determined based on an insufficiency by the machine learning model to identify vehicles with rear windows that have drawings. Augmentation criteria can specify the augmented data to include vehicles with rear windows that have drawings. Based on the augmentation criteria, base templates that include vehicles can be determined. Further, based on the augmentation criteria, components that include rear windows that have drawings can be determined. The components can be applied to the base templates to generate augmented data that include vehicles with rear windows that have drawings. In another instance, components of vehicles, such as doors, bumpers, wheels, and windows, can be added to base templates to generate augmented data that includes a broad range of different vehicles. Such augmented data can supplement and diversify a set of training data so that, when trained by the set of training data including the augmented data, a machine learning model can more robustly and comprehensively identify a wide array of different vehicles. Many variations are possible.

FIG. 2A illustrates an example block diagram 200 associated with generating a template library, according to some embodiments of the present technology. The various functionality described herein for generating the template library can be performed by, for example, the augmented data module 100 of FIG. 1. It should be understood that there can be additional, fewer, or alternative steps performed in similar or alternative orders, or in parallel, based on the various features and embodiments discussed herein unless otherwise stated.

As illustrated in FIG. 2A, images 202 can be provided to an object detection module 204. The object detection module 204 can detect objects in the images 202. The objects can be detected based on one or more machine learning models trained to identify objects. Based on the objects identified in the images 202, bounding boxes and labels can be associated with the identified objects. The images 202 and the associated bounding boxes and labels for the objects identified in the images 202 can be stored in the template library 208. As illustrated in FIG. 2A, images 202 can be provided to a manual template module 206. The manual template module 206 can facilitate manual identification and labeling of objects in the images 202. A user can identify objects in the images 202 and associate bounding boxes and labels with the objects in the images 202. The images 202 and the associated bounding boxes and labels for the objects identified in the images 202 can be stored in the template library 208. Many variations are possible.

FIG. 2B illustrates an example block diagram 250 associated with generating a component library, according to some embodiments of the present technology. The various functionality described herein for generating the component library can be performed by, for example, the augmented data module 100 of FIG. 1. It should be understood that there can be additional, fewer, or alternative steps performed in similar or alternative orders, or in parallel, based on the various features and embodiments discussed herein unless otherwise stated.

As illustrated in FIG. 2B, images 252 can be provided to a component detection module 254. The component detection module 254 can detect components in the images 252. The components can be detected based on one or more machine learning models trained to identify components. Based on the components identified in the images 252, labels can be associated with the identified components. The identified components and associated labels can be stored in the component library 262. As illustrated in FIG. 2B, seeds 256, such as random noise or specified input, can be provided to a component generation module 258. The component generation module 258 can generate components based on the seeds 256. Based on the components generated from the seeds 256, labels can be associated with the generated components. The generated components and associated labels can be stored in the component library 262. As illustrated in FIG. 2B, a manual component module 260 can facilitate manual generation and labeling of components. A user can generate components and associate labels with the generated components. The generated components and associated labels can be stored in the component library 262. Many variations are possible.

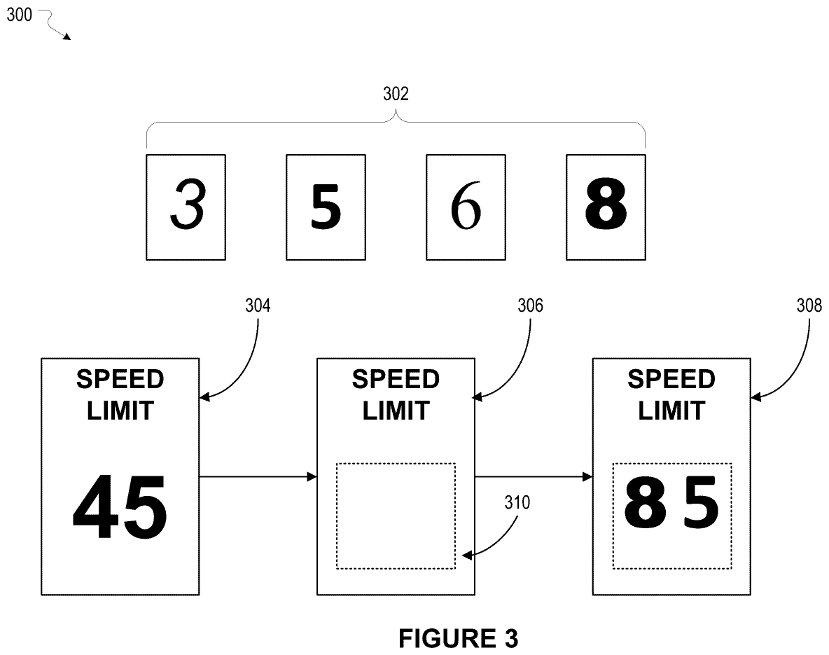

FIG. 3 illustrates an example diagram 300 of generating augmented data, according to some embodiments of the present technology. The various functionality described herein for generating the augmented data can be performed by, for example, the augmented data module 100 of FIG. 1. It should be understood that there can be additional, fewer, or alternative steps performed in similar or alternative orders, or in parallel, based on the various features and embodiments discussed herein unless otherwise stated.

As illustrated in FIG. 3, a base template 304 includes a speed limit sign with a speed limit of 45. The base template 304 can be selected from a template library based on augmentation criteria that specify augmented data that includes speed limit signs. The base template 304 can be prepared for generating augmented data by removing a portion of the base template 304 to produce a prepared base template 306. The prepared base template 306 includes a portion 310 corresponding with where speed limit digits on the speed limit sign have been removed, allowing the prepared base template 306 to be modified with components to generate augmented data 308. The augmented data 308 can be generated based on the prepared base template 306 and components 302. The components 302 can be maintained in a component library. The components selected for the augmented data 308 can be selected based on the augmentation criteria. In this example, the augmentation criteria can specify that the augmented data 308 should include a speed limit sign with a speed limit of 85. Many variations are possible.

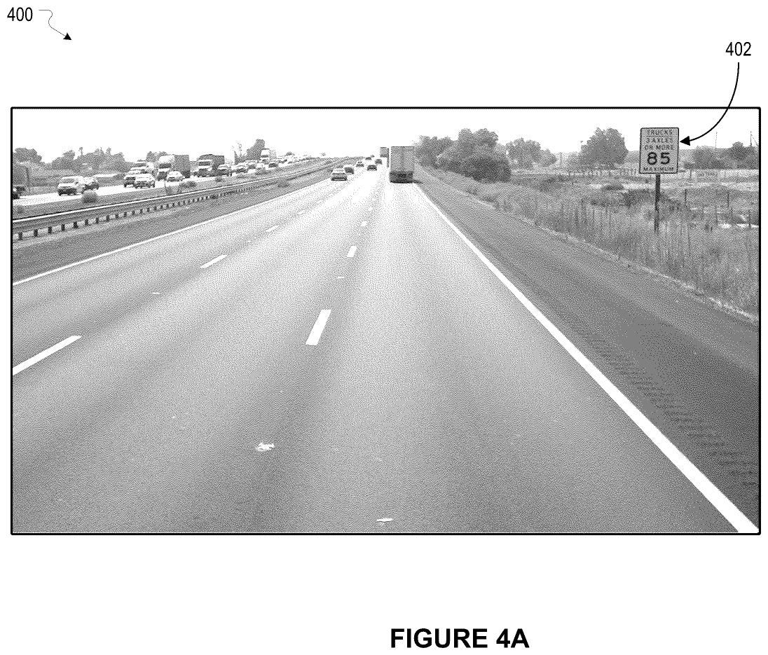

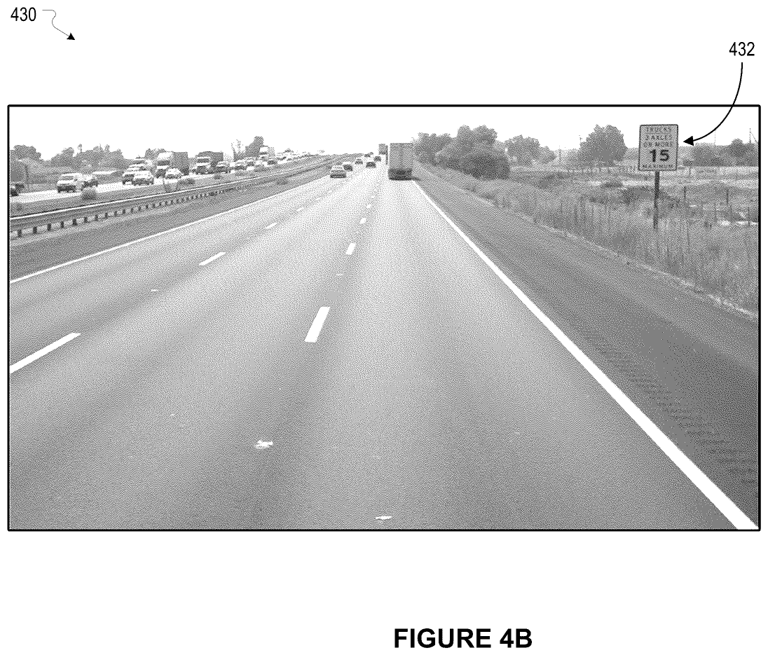

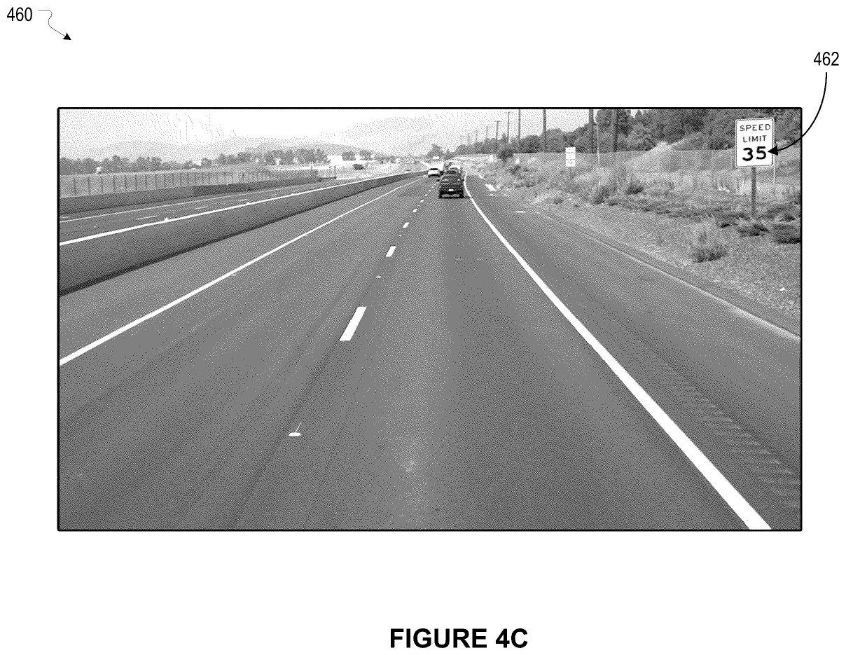

FIGS. 4A-4C illustrate examples of augmented data, according to some embodiments of the present technology. The augmented data can be generated by, for example, the augmented data module 100 of FIG. 1. It should be understood that there can be additional, fewer, or alternative steps performed in similar or alternative orders, or in parallel, based on the various features and embodiments discussed herein unless otherwise stated.

FIG. 4A illustrates an example 400 of augmented data. As illustrated in FIG. 4A, the example 400 of augmented data includes an image of a highway environment. The image of the highway environment includes a speed limit sign 402 with a speed limit of “85”. In this example, the augmented data can be generated based on a base template and components added to the base template. The base template can include the image of the highway environment with a portion corresponding with the speed limit removed (or replaced with a background color). The components can include “8” and “5” as speed limit digits. The augmented data can be generated based on a modification of the base template that adds the components to generate the speed limit sign 402 with the speed limit of “85”. As training data, the augmented data can include or be associated with a label that the image of the highway environment depicts a speed limit sign with a speed limit of 85. Many variations are possible.

FIG. 4B illustrates an example 430 of augmented data. As illustrated in FIG. 4B, the example 430 of augmented data includes an image of a highway environment. The image of the highway environment includes a speed limit sign 432 with a speed limit of “15”. In this example, the augmented data can be generated based on a base template and components added to the base template. The base template can be the base template illustrated in the example 400 in FIG. 4A. The base template can include the image of the highway environment with a portion corresponding with the speed limit removed (or replaced with a background color). The components can include “1” and “5” as speed limit digits. The augmented data can be generated based on a modification of the base template that adds the components to generate the speed limit sign 432 with the speed limit of “15”. As training data, the augmented data can include or be associated with a label that the image of the highway environment depicts a speed limit sign with a speed limit of 15. Many variations are possible.

FIG. 4C illustrates an example 460 of augmented data. As illustrated in FIG. 4C, the example 460 of augmented data includes an image of a highway environment. The image of the highway environment includes a speed limit sign 462 with a speed limit of “35”. In this example, the augmented data can be generated based on a base template and components added to the base template. The base template can include the image of the highway environment with a portion corresponding with the speed limit removed (or replaced with a background color). The components can include “3” and “5” as speed limit digits. The augmented data can be generated based on a modification of the base template that adds the components to generate the speed limit sign 462 with the speed limit of 35. As training data, the augmented data can include or be associated with a label that the image of the highway environment depicts a speed limit sign with a speed limit of 35. Many variations are possible.

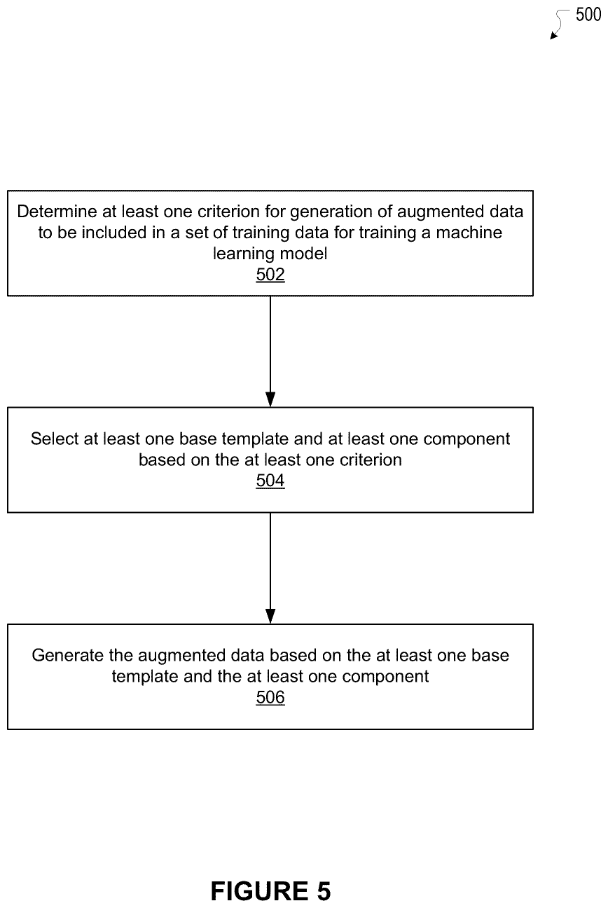

FIG. 5 illustrates an example method 500, according to embodiments of the present technology. At block 502, the example method 500 determines at least one criterion for generation of augmented data to be included in a set of training data for training a machine learning model. At block 504, the example method 500 selects at least one base template and at least one component based on the at least one criterion. At block 506, the example method 500 generates the augmented data based on the at least one base template and the at least one component. Many variations to the example method are possible. It should be appreciated that there can be additional, fewer, or alternative steps performed in similar or alternative orders, or in parallel, within the scope of the various embodiments discussed herein unless otherwise stated.

It is contemplated that there can be many other uses, applications, and/or variations associated with the various embodiments of the present technology. For example, various embodiments of the present technology can learn, improve, and/or be refined over time.

### Example Implementations

FIG. 6 illustrates a vehicle 600 including an autonomous system 610, according to various embodiments of the present technology. The functionality and operation of the present technology, including the autonomous system 610, can be implemented in whole or in part by the vehicle 600. The present technology can cause desired control and navigation of the vehicle 600, as described herein. In some embodiments, the vehicle 600 is a truck, which can include a trailer. The truck can be of any size (e.g., medium truck, heavy truck, very heavy truck, etc.) or weight (e.g., greater than 14,000 pounds, greater than 26,000 pounds, greater than 70,000 pounds, etc.). The autonomous system 610 of the vehicle 600 can support and execute various modes of navigation of the vehicle 600. The autonomous system 610 can support and execute an autonomous driving mode, a semi-autonomous driving mode, and a driver assisted driving mode of the vehicle 600. The autonomous system 610 also can enable a manual driving mode. For operation of the vehicle 600, the autonomous system 610 can execute or enable one or more of the autonomous driving mode, the semi-autonomous driving mode, the driver assisted driving mode, and the manual driving mode, and selectively transition among the driving modes based on a variety of factors, such as operating conditions, vehicle capabilities, and driver preferences.

In some embodiments, the autonomous system 610 can include, for example, a perception module 612, a localization module 614, a prediction and planning module 616, and a control module 618. The functionality of the perception module 612, the localization module 614, the prediction and planning module 616, and the control module 618 of the autonomous system 610 are described in brief for purposes of illustration. The components (e.g., modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the autonomous system 610 can be implemented in any suitable combinations.

The perception module 612 can receive and analyze various types of data about an environment in which the vehicle 600 is located. Through analysis of the various types of data, the perception module 612 can perceive the environment of the vehicle 600 and provide the vehicle 600 with critical information so that planning of navigation of the vehicle 600 is safe and effective. For example, the perception module 612 can determine the pose, trajectories, size, shape, and type of obstacles in the environment of the vehicle 600. Various models, such as machine learning models, can be utilized in such determinations.

The various types of data received by the perception module 812 can be any data that is supportive of the functionality and operation of the present technology. For example, the data can be attributes of the vehicle 600, such as location, velocity, acceleration, weight, and height of the vehicle 600. As another example, the data can relate to topographical features in the environment of the vehicle 600, such as traffic lights, road signs, lane markers, landmarks, buildings, structures, trees, curbs, bodies of water, etc. As yet another example, the data can be attributes of dynamic obstacles in the surroundings of the vehicle 600, such as location, velocity, acceleration, size, type, and movement of vehicles, persons, animals, road hazards, etc.

Sensors can be utilized to capture the data. The sensors can include, for example, cameras, radar, LiDAR (light detection and ranging), GPS (global positioning system), IMUs (inertial measurement units), and sonar. The sensors can be appropriately positioned at various locations (e.g., front, back, sides, top, bottom) on or in the vehicle 600 to optimize the collection of data. The data also can be captured by sensors that are not mounted on or in the vehicle 600, such as data captured by another vehicle (e.g., another truck) or by non-vehicular sensors located in the environment of the vehicle 600.

The localization module 614 can determine the pose of the vehicle 600. Pose of the vehicle 600 can be determined in relation to a map of an environment in which the vehicle 600 is traveling. Based on data received by the vehicle 600, the localization module 614 can determine distances and directions of features in the environment of the vehicle 600. The localization module 614 can compare features detected in the data with features in a map (e.g., HD map) to determine the pose of the vehicle 600 in relation to the map. The features in the map can include, for example, traffic lights, crosswalks, road signs, lanes, road connections, stop lines, etc. The localization module 614 can allow the vehicle 600 to determine its location with a high level of precision that supports optimal navigation of the vehicle 600 through the environment.

The prediction and planning module 616 can plan motion of the vehicle 600 from a start location to a destination location. The prediction and planning module 616 can generate a route plan, which reflects high level objectives, such as selection of different roads to travel from the start location to the destination location. The prediction and planning module 616 also can generate a behavioral plan with more local focus. For example, a behavioral plan can relate to various actions, such as changing lanes, merging onto an exit lane, turning left, passing another vehicle, etc. In addition, the prediction and planning module 616 can generate a motion plan for the vehicle 800 that navigates the vehicle 600 in relation to the predicted location and movement of other obstacles so that collisions are avoided. The prediction and planning module 616 can perform its planning operations subject to certain constraints. The constraints can be, for example, to ensure safety, to minimize costs, and to enhance comfort.

Based on output from the prediction and planning module 616, the control module 618 can generate control signals that can be communicated to different parts of the vehicle 600 to implement planned vehicle movement. The control module 618 can provide control signals as commands to actuator subsystems of the vehicle 600 to generate desired movement. The actuator subsystems can perform various functions of the vehicle 600, such as braking, acceleration, steering, signaling, etc.

The autonomous system 610 can include a data store 620. The data store 620 can be configured to store and maintain information that supports and enables operation of the vehicle 600 and functionality of the autonomous system 610. The information can include, for example, instructions to perform the functionality of the autonomous system 610, data captured by sensors, data received from a remote computing system, parameter values reflecting vehicle states, map data, machine learning models, algorithms, vehicle operation rules and constraints, navigation plans, etc.

The autonomous system 610 of the vehicle 600 can communicate over a communications network with other computing systems to support navigation of the vehicle 600. The communications network can be any suitable network through which data can be transferred between computing systems. Communications over the communications network involving the vehicle 600 can be performed in real time (or near real time) to support navigation of the vehicle 600.

The autonomous system 610 can communicate with a remote computing system (e.g., server, server farm, peer computing system) over the communications network. The remote computing system can include an autonomous system, and perform some or all of the functionality of the autonomous system 610. In some embodiments, the functionality of the autonomous system 610 can be distributed between the vehicle 600 and the remote computing system to support navigation of the vehicle 600. For example, some functionality of the autonomous system 610 can be performed by the remote computing system and other functionality of the autonomous system 610 can be performed by the vehicle 600. In some embodiments, a fleet of vehicles including the vehicle 600 can communicate data captured by the fleet to a remote computing system controlled by a provider of fleet management services. The remote computing system in turn can aggregate and process the data captured by the fleet. The processed data can be selectively communicated to the fleet, including vehicle 600, to assist in navigation of the fleet as well as the vehicle 600 in particular. In some embodiments, the autonomous system 610 of the vehicle 600 can directly communicate with a remote computing system of another vehicle. For example, data captured by the other vehicle can be provided to the vehicle 600 to support navigation of the vehicle 600, and vice versa. The vehicle 600 and the other vehicle can be owned by the same entity in some instances. In other instances, the vehicle 600 and the other vehicle can be owned by different entities.

In various embodiments, the functionalities described herein with respect to the present technology can be implemented, in part or in whole, as software, hardware, or any combination thereof. In some cases, the functionalities described with respect to the present technology can be implemented, in part or in whole, as software running on one or more computing devices or systems. In a further example, the functionalities described with respect to the present technology can be implemented using one or more computing devices or systems that include one or more servers, such as network servers or cloud servers. It should be understood that there can be many variations or other possibilities.

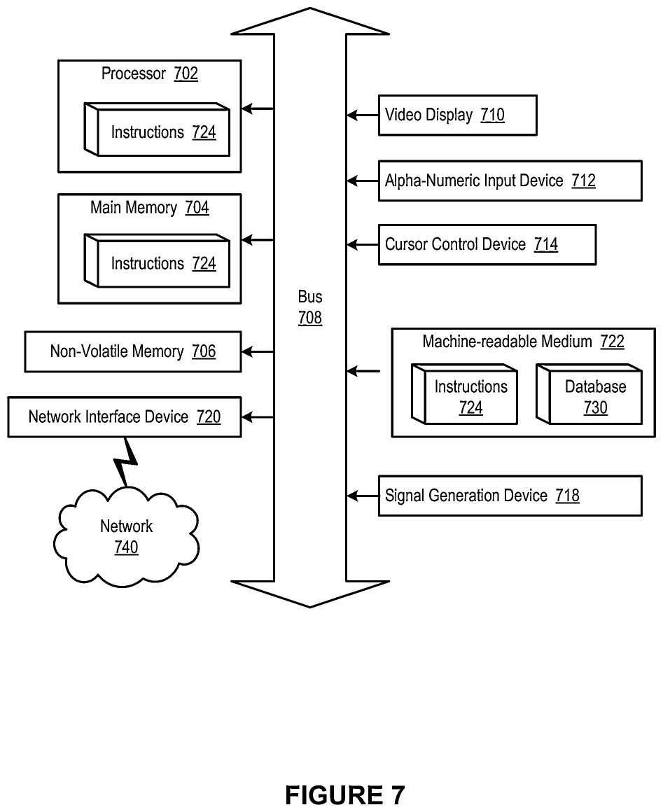

FIG. 7 illustrates an example of a computer system 700 that may be used to implement one or more of the embodiments of the present technology. The computer system 700 can be included in a wide variety of local and remote machine and computer system architectures and in a wide variety of network and computing environments that can implement the functionalities of the present technology. The computer system 700 includes sets of instructions 724 for causing the computer system 700 to perform the functionality, features, and operations discussed herein. The computer system 700 may be connected (e.g., networked) to other machines and/or computer systems. In a networked deployment, the computer system 700 may operate in the capacity of a server or a client machine in a client-server network environment, or as a peer machine in a peer-to-peer (or distributed) network environment.

The computer system 700 includes a processor 702 (e.g., a central processing unit (CPU), a graphics processing unit (GPU), or both), a main memory 704, and a nonvolatile memory 706 (e.g., volatile RAM and non-volatile RAM, respectively), which communicate with each other via a bus 708. In some embodiments, the computer system 700 can be a desktop computer, a laptop computer, personal digital assistant (PDA), or mobile phone, for example. In one embodiment, the computer system 700 also includes a video display 710, an alphanumeric input device 712 (e.g., a keyboard), a cursor control device 714 (e.g., a mouse), a signal generation device 718 (e.g., a speaker) and a network interface device 720.

In one embodiment, the video display 710 includes a touch sensitive screen for user input. In one embodiment, the touch sensitive screen is used instead of a keyboard and mouse. The machine-readable medium 722 on which is stored one or more sets of instructions 724 (e.g., software) embodying any one or more of the methodologies, functions, or operations described herein. The instructions 724 can also reside, completely or at least partially, within the main memory 704 and/or within the processor 702 during execution thereof by the computer system 700. The instructions 724 can further be transmitted or received over a network 740 via the network interface device 720. In some embodiments, the machine-readable medium 922 also includes a database 730.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 706 may also be a random access memory. The non-volatile memory 706 can be a local device coupled directly to the rest of the components in the computer system 700. A non-volatile memory that is remote from the system, such as a network storage device coupled to any of the computer systems described herein through a network interface such as a modem or Ethernet interface, can also be used.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 600 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually affect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in various embodiments,” “in an example,” “in one implementation,” or the like means that a particular feature, design, structure, or characteristic described in connection with the embodiment is included in at least one embodiment of the technology. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the technology of the embodiments of the invention is intended to be illustrative, but not limiting, of the scope of the invention, which is set forth in the following claims.

1. A computer-implemented method comprising:
determining, by a computing system, at least one criterion for generation of augmented image data to be included in a set of training data for training a machine learning model, wherein the at least one criterion specifies a range of values to be depicted by an object in the augmented image data to diversify the set of training data;
selecting, by the computing system, at least one base template that depicts the object, a first component from a first image, and a second component from a second image, wherein a first digit from the first component and a second digit from the second component form a value that satisfies the range of values based on the at least one criterion;
generating, by the computing system, the augmented image data based on an application of the first component and the second component to the at least one base template;
training, by the computing system, the machine learning model to identify the object based on the set of training data diversified by the augmented image data; and
supporting, by the computing system, operation of a vehicle based on the trained machine learning model.

2. The computer-implemented method of claim 1, wherein the selecting comprises:
determining, by the computing system, at least one image that depicts the object based on the at least one criterion; and
generating, by the computing system, the first component based on a part of the object.

3. The computer-implemented method of claim 1, wherein the selecting comprises:
determining, by the computing system, a seed for generating the first image for the first component; and
generating, by the computing system, the first image for the first component based on the seed.

4. The computer-implemented method of claim 1, wherein the selecting comprises:
selecting, by the computing system, the first component from a component library based on the at least one criterion.

5. The computer-implemented method of claim 1, wherein the selecting comprises:
determining, by the computing system, at least one image that depicts the object based on the at least one criterion; and
generating, by the computing system, the at least one base template based on removal of a portion of the object depicted in the at least one image.

6. The computer-implemented method of claim 1, wherein the selecting comprises:
selecting, by the computing system, the at least one base template from a template library; and
removing, by the computing system, a portion of the at least one base template based on the at least one criterion.

7. The computer-implemented method of claim 6, wherein the removing the portion of the at least one base template comprises:
replacing, by the computing system, the portion of the at least one base template with a background color.

8. The computer-implemented method of claim 1, wherein the generating the augmented image data comprises:
modifying, by the computing system, a portion of the at least one base template to include the first component and the second component based on the at least one criterion.

9. The computer-implemented method of claim 1, wherein the augmented image data is labeled based on the at least one base template, the first component, and the second component.

10. The computer-implemented method of claim 1, wherein the determining the at least one criterion comprises:
determining, by the computing system, a number of training data examples that include objects that depict values in the range of values; and
determining, by the computing system, an insufficiency in diversity of the set of training data based on a determination the number of training data examples is below a threshold.

11. A system comprising:
at least one processor; and
a memory storing instructions that, when executed by the at least one processor, cause the system to perform operations comprising:
determining at least one criterion for generation of augmented image data to be included in a set of training data for training a machine learning model, wherein the at least one criterion specifies a range of values to be depicted by an object in the augmented image data to diversify the set of training data;
selecting at least one base template that depicts the object, a first component from a first image, and a second component from a second image, wherein a first digit from the first component and a second digit from the second component form a value that satisfies the range of values based on the at least one criterion;
generating the augmented image data based on an application of the first component and the second component to the at least one base template;
training the machine learning model to identify the object based on the set of training data diversified by the augmented image data; and
supporting operation of a vehicle based on the trained machine learning model.

12. The system of claim 11, wherein the selecting comprises:
determining at least one image that depicts the object based on the at least one criterion; and
generating the first component based on a part of the object.

13. The system of claim 11, wherein the selecting comprises:
determining a seed for generating the first image for the first component; and
generating the first image for the first component based on the seed.

14. The system of claim 11, wherein the selecting comprises:
selecting the first component from a component library based on the at least one criterion.

15. The system of claim 11, wherein the selecting comprises:
determining at least one image that depicts the object based on the at least one criterion; and
generating the at least one base template based on removal of a portion of the object depicted in the at least one image.

16. A non-transitory computer-readable storage medium including instructions that, when executed by at least one processor of a computing system, cause the computing system to perform operations comprising:
determining at least one criterion for generation of augmented image data to be included in a set of training data for training a machine learning model, wherein the at least one criterion specifies a range of values to be depicted by an object in the augmented image data to diversify the set of training data;
selecting at least one base template that depicts the object, a first component from a first image, and a second component from a second image, wherein a first digit from the first component and a second digit from the second component form a value that satisfies the range of values based on the at least one criterion;
generating the augmented image data based on an application of the first component and the second component to the at least one base template;
training the machine learning model to identify the object based on the set of training data diversified by the augmented image data; and
supporting operation of a vehicle based on the trained machine learning model.

17. The non-transitory computer-readable storage medium of claim 16, wherein the selecting comprises:
determining at least one image that depicts the object based on the at least one criterion; and
generating the first component based on a part of the object.

18. The non-transitory computer-readable storage medium of claim 16, wherein the selecting comprises:
determining a seed for generating the first image for the first component; and
generating the first image for the first component based on the seed.

19. The non-transitory computer-readable storage medium of claim 16, wherein the selecting comprises:
selecting the first component from a component library based on the at least one criterion.

20. The non-transitory computer-readable storage medium of claim 16, wherein the selecting comprises:
determining at least one image that depicts the object based on the at least one criterion; and
generating the at least one base template based on removal of a portion of the object depicted in the at least one image.
